(19) United States
(12) Patent Application Publication
(10) Pub. No.: US 2006/0011407 A1
(43) Pub. Date: Jan. 19, 2006

(54) Power-assisted steering system of a motor vehicle

(76) Inventors: Wolfgang Reinelt, Stuttgart (DE); Willy Klier, Schwaebisch Gmuend (DE); Wolfgang Schuster, Abtsgmuend (DE); Reinhard Grossheim, Boebingen (DE)

Correspondence Address: JORDAN AND HAMBURG LLP, 122 EAST 42ND STREET, SUITE 4000, NEW YORK, NY, 10168, US

(21) Appl. No.: 11/134,581

(22) Filed: May 19, 2005

(30) Foreign Application Priority Data
Jun. 15, 2004 (DE) 10 2004 028 826.7

(51) Int. Cl. B62D 5/06

(52) U.S. Cl. 180/426

(57) ABSTRACT

The invention relates to a power-assisted steering system of a motor vehicle with a steering handing device for specifying a steering wheel angle as a measure of a desired steering angle for at least one steerable wheel of the motor vehicle, a steering gear with a pinion, which converts a pinion angle, which depends on the steering wheel angle, into the steering angle of the at least one steerable wheel of the motor vehicle, superimposing means for producing an additional angle and for producing the pinion angle from superimposing the additional angle on the steering wheel angle and a servo drive with an electronically controllable hydraulic pump for realizing a variable moment support, the amount, flowing through the electronically controllable hydraulic pump being determined as a function of a rotational speed of the pinion angle (\dot{δ}_{G}) and controlled by a control signal (i_{d}) of a control device of the steering system.

The invention relates to a power-assisted steering system of a motor vehicle. The steering system comprises a steering handling device for specifying a steering wheel angle as a measure for a desired steering angle for at least one steerable wheel of the motor vehicle. In addition, the steering system comprises a power-assisted driving mechanism for realizing a variable moment support and superimposing means, which generate an additional angle and are superimposed on the steering wheel angle, specified by the steering handling device, especially for realizing a variable steering gear ratio with the additional angle.

The invention also relates to a method for operating such a power-assisted steering system.

The invention likewise relates to a computer program and a computer program product with program coding means, in order to carry out the method for operating the power-assisted steering program on a computer, especially on a microprocessor, a control device of the power-assisted steering system and such a control device.

The DE 100 13 711 A1 discloses a steering system, which, among other things, comprises a servo drive as moment support (power-assisted steering). For the steering system described, the degree of moment support depends on the speed of the vehicle. At slow vehicle speeds, the moment support is greater (for example, in order to be able to operate the steering wheel without great effort when maneuvering the vehicle). On the other hand, the moment support is lowered at higher speeds (for example, in order to increase the driving stability on the freeway). The servo drive may be operated electrically or hydraulically. For the inventive steering system, the moment support can be varied hydraulically.

The steering system, described in DE 100 13 711 A, has a servo drive, as well as superimposing means, which generate an additional angle and the additional angle is superimposed on the steering wheel angle specified by the steering handling device. A steering system with superimposing means is, moreover, known from DE 197 51 125 A1. The steering wheel angle is superimposed on the movement (additional angle or motor angle) of a control device, that is, an electric motor, by means of a superimposing transmission (such as a planetary gear). With the help of the superimposing means, it is possible to superimpose an additional angle on the steering wheel angle, specified by the steering handling device, in order to increase the driving stability or the comfort, so that variable transformation ratio between the steering wheel angle and the average steering angle of the steerable wheels of the motor vehicle, which depends on the driving dynamics and comfort, is achieved. By these means, it is, for example, possible, from a safety point of view, to restore a motor vehicle, which is threatening to swerve, to a stable driving situation by an appropriate correction of the steering angle. The superimposing means can support other driving dynamics systems (such as an electronic stability program (ESP) or an anti-blocking system (ABS). From a comfort point of view, it is also possible, for example, to superimpose a speed-dependent additional angle on a steering wheel angle. By these means, the transformation ratio can be set to a relatively small value at low driving speeds, that is, a relatively small rotation of the steering handling device leads to a relatively large steering angle of the wheels. On the other hand, at high vehicle speeds, a relatively large transformation ratio can be set, so that the driving stability of the motor vehicle is increased. The inventive steering system also has superimposing means.

In order to be able to utilize a superimposed steering system optimally, the amount flowing through hydraulically is higher in the case of a servo drive than in the case of a conventional power-assisted steering system, since, in comparison to the conventional power-assisted steering systems, the superimposing steering systems have a clearly higher output power at the gear rack. Moreover, greater thermal stresses and an increased consumption of fuel may occur.

Moreover, undesirable moments may arise if an additional angle is superimposed by the superimposing means on the steering handling device.

It is therefore an object of the present invention to create a steering system, a method for operating a steering system, a computer program, a computer program product and a control device of the type mentioned above, which avoid the disadvantages of the state of the art, and, in particular, minimize thermal stresses and prevent increased consumption of fuel and, moreover, ensure suitable adjusting dynamics and a moment-compatible angle superimposition.

Pursuant to the invention, this objective is accomplished by claim 1. With respect to the method, the computer program, the computer program product and the control device, the objective is accomplished by claims 7, 9, 10 and 11.

In order to minimize thermal stresses and to prevent increased consumption of fuel, the servo drive of the inventive steering system works with an electronically controllable hydraulic pump, which, for example, is known from DE 102 05 859 A1. The energy balance within the steering system can be improved clearly by means of such a hydraulic pump in comparison to a hydraulic pump with a constant high flow rate, since the amount flowing through or pumped can be controlled by the hydraulic pump. For this purpose, a hydraulic useful function of the steering system operates the flow rate of the hydraulic pump as a function of a suitable vehicle parameter, namely the angular velocity of the pinion angle (corresponds to the first derivative of the pinion angle with respect to time), which arises from superimposing the additional angle on the steering wheel angle. By these means, suitable adjusting dynamics and a moment-compatible superimposition are achieved. The angular velocity of the pinion angle represents a characteristic number of the activity of the steering system and contains the effects of the steering handling device as well as those of the superimposed additional angle of the superimposing means. In this connection, the inventors have noted that the selection of the additional angle instead of the pinion angle is less advantageous, since the latter may partially also be negative (that is, counter to the actual direction of rotation) and, with that, an unnecessary increase in the amount flowing through would occur in this case.

For triggering the servo drive and the superimposing means, the steering system has an electronic control device, on which the inventive method for operating the steering system takes its course. The control device receives, as input quantities, the steering wheel angle, the pinion angle or its rotational speed, the vehicle speed or the like from sensors and/or other vehicle systems or calculates these quantities because of other quantities of the steering system or the motor vehicle. Because of these input quantities, appropriate electrical triggering signals for triggering the servo drive and the superimposing means are determined.

It is advantageous to trigger the hydraulic pump by the inventive method for operating the steering system as a function of the vehicle speed, since the external forces, which act on the steering system, depend directly on the vehicle speed. The moment support should be larger at slow vehicle speeds, for example, in order to be able to operate the steering wheel without much force when maneuvering the vehicle. On the other hand, the moment support should be lowered at higher speeds, for example, in order to increase the driving stability on a freeway.

It is advantageous if the amount flowing through the electronically controllable hydraulic pump is increased, especially proportionally, when the rotational speed of the pinion angle increases.

The inventive steering system makes a safe and quiet steering of the motor vehicle possible. The steering sensation while driving is improved. Any reaction moments, caused by the intervention of the superimposing means and possibly having an interfering effect on the steering handling device, are clearly reduced in a simple and advantageous manner. A proportional increase admittedly is aimed for, but is, however, not possible or meaningful in all regions, since it is necessary to react significantly more quickly at low vehicle speeds and very high rotational speeds of the pinion angle and, accordingly, a higher gradient must be used. Moreover, the maximum control dynamics of the hydraulic pump must be taken into consideration. Under some circumstances, therefore, a certain reserve ought to be provided. These dependencies can be filed, for example, in an appropriate, characteristic diagram.

The amount flowing through the electronically controllable hydraulic pump is determined by a hydraulic useful function of the process taking place on the control device for operating the steering system.

It is advantageous if the hydraulic useful function has at least two partial functions,
the first partial function initiating suitable measures, when the input quantities of the control device are defective and
the second partial function determining the signal for controlling the amount flowing through the electronically controllable hydraulic pump.

By these means, appropriate measures are taken when the input signals of the control device, especially the rotational speed of the pinion angle or the vehicle speed, are defective.

The method for operating the inventive steering system is realized advantageously as a computer program on the control device of the steering system. For this purpose, the computer program is stored in a memory element of the control device. The process is carried out by running the program on a microprocessor of the control device. The computer program may be stored on a computer-readable data storage medium (diskette, CD, DVD, hard drive, USB memory stick, or the like) or on an Internet server as computer program product and transferred from there into the storage element of the control device.

Advantageous further developments and refinements of the invention arise from the dependent claims. In the following, an example of the invention is shown in principle by means of the drawing, in which

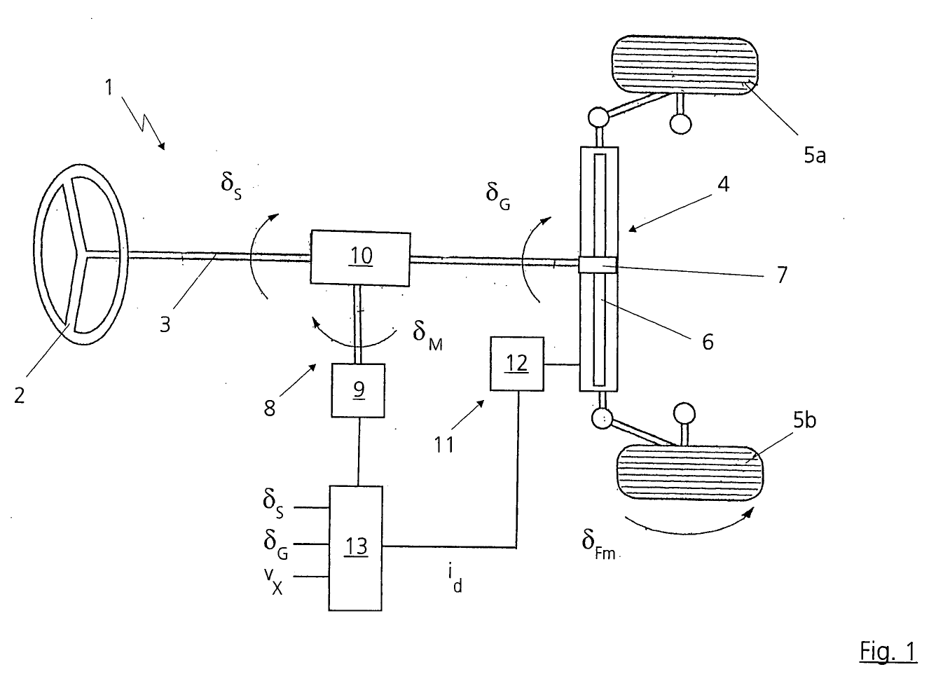

FIG. 1 shows a diagrammatic representation of an inventive steering system and

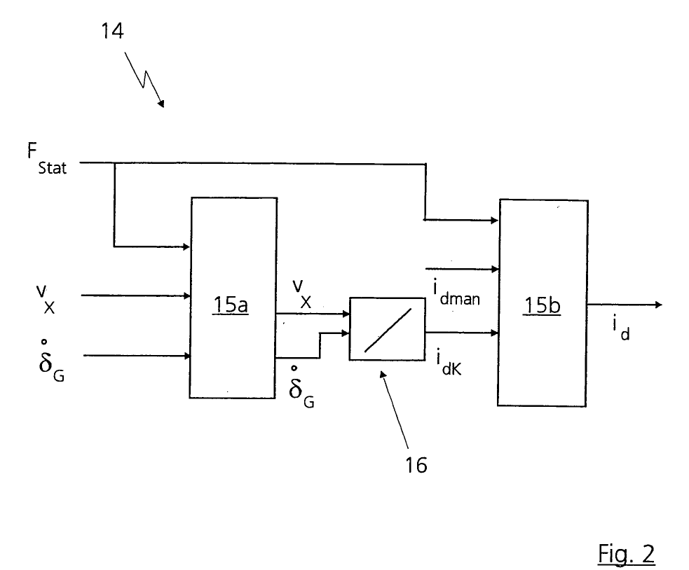

FIG. 2 shows a diagrammatic representation of a hydraulic useful function, which is capable of running on a control device of the steering system of FIG. 1.

FIG. 1 shows an inventive steering system 1 of a motor vehicle. The steering system 1 has a steering handling device 2, which is constructed as a steering wheel. The steering wheel 2 is connected over an articulated shaft 3 with a steering gear 4. The function of the steering gear 4 is to convert an angle of rotation of the articulated joint 3 into a steering angle δ_{Fm} of steerable wheels 5a, 5b of the motor vehicle. The steering gear 4 has a gear rack 6 and a pinion 7, at which the articulated joint 3 engages. The steering system 1 moreover comprises superimposing means 8, which have a control drive 9, constructed as an electric motor, and a superimposing transmission 10, driven by the control drive 9. The superimposing gear is constructed as a planetary gearing 10. A steering wheel angle δ_{S} is then specified by the steering wheel 2 as a measure of a desired steering angle δ_{Fm} of the steerable wheels 5a, 5b of the motor vehicle. With the help of the electric motor 9, an additional angle δ_{M} is generated and the steering wheel angle δ_{S} is superimposed on it by the superimposing gear. The additional angle or motor angle δ_{M} is produced to improve driving dynamics of the motor vehicle or the comfort. The pinion angle δ_{G} is equal to the sum of the steering wheel angle δ_{S} and the additional angle δ_{M}.

Downstream from the superimposing means 8, the steering system 1 has a servo drive 11, which, in particular, supports the variable moment and is also referred to as an electro-hydraulic converter. The servo drive 11 comprises an electronically controllable hydraulic pump 12, which transports a hydraulic fluid over a hydraulic valve (the details of which are not sharing) into the steering gear 4. The flow of hydraulic fluid is directed over the hydraulic valve to the one or the other end of the gear rack 6, in order to thus bring about a corresponding moment support in the desired direction. The magnitude of the moment support can be varied by the amount or the pressure of the hydraulic fluid directed into the steering gear 4 (that is, a housing of the steering gear 4). Pursuant to the invention, this is accomplished by the electronically controllable hydraulic pump 12.

In order to minimize thermal stresses and prevent increased fuel consumption, the servo drive 11 of the inventive steering system 1 is operated by means of the electronically controllable hydraulic pump 12, which is known, for example, from DE 102 05 859 A1. Due to the hydraulic pump 12, it is possible to improve the energy balance within the steering system 1 in comparison to that of a hydraulic pump with a constant high flow rate.

Moreover, the steering system 1 has a control device 13, which is used, among other things, for triggering the electric motor 9 and the electronically controllable hydraulic pump 12. On the electronic control device 13, a method for operating the steering system 1 is running. By these means, among other things, the electric motor 9 is triggered by an electric triggering signal δ_{Md} and the hydraulic pump 12 is triggered by an electric triggering signal i_{d}. This triggering takes place, for instance, as a function of the vehicle speed v_{X}. Accordingly, it is possible to select a high moment support at low vehicle speeds v_{X}, in order to make it easier to maneuver the vehicle, and to specify a low moment support at high speeds v_{X} (more stable steering). Similarly, the electric motor 9 is triggered as a function of the vehicle speed v_{X}, that is, the gear ratio between the steering wheel angle δ_{S} and the pinion angle δ_{G} or the steering angle δ_{Fm} of the wheels 5a, 5b is set by superimposing different, vehicle speed-dependent additional angles δ_{M} on the steering angle δ_{S}. By these means, it is possible to specify a relatively small gear ratio at low vehicle speeds v_{X}, so that a relatively slight rotation of the steering wheel 2 leads to a relatively large steering angle δ_{Fm} of the wheels 5a, 5b. Likewise, at high vehicle speeds v_{X} it is conceivable to specify a relatively large gear ratio for stability reasons. This dependency of the control on the speed v_{X} of the vehicle is, however, not absolutely essential.

So that the control functions, listed above, can be carried out, the steering device 13 receives the actual vehicle speed v_{X} as input signal In addition, the steering system 1 has sensors (not shown), which measure the steering wheel angle δ_{S}, the additional angle δ_{M} and the pinion angle δ_{G} or even already the rotational speed of the latter. The control device 13 is provided by these sensors with the angle quantities δ_{S}, δ_{M} and δ_{G} or already with their rotational speeds δ_{G} as input signals. Moreover, these quantities can also be supplied by other vehicle systems (over a CAN bus) or, on the basis of further input quantities (such as the rotational speed of the wheels, etc.) calculated by the control device 13 by means of a suitable model of the steering system. By these means, control, especially of the amount flowing through the hydraulic pump 12, becomes possible also as a function of these quantities. As is evident from FIG. 1, the control device 13 receives at least the steering wheel angle δ_{S}, the pinion angle δ_{G} and the actual vehicle speed v_{X} as input signals.

The rotational speed of the pinion angle G represents a characteristic number for the activity of the steering system 1 and contains the effects of the superimposed additional angle δ_{M} of the superimposing agents 8. Pursuant to the invention, provisions are made for controlling the flow rate through the electronically controllable hydraulic pump 12 as a function of the rotational speed of the pinion angle δ_{G}. It is particularly advantageous if the amount, flowing through the hydraulic pump 12, is increased proportionally when the rotational speed of the pinion angle δ_{G} is increased.

The inventive steering system 1 accordingly enables the motor vehicle to be steered safely and quietly. The steering sensation while driving is improved. Due to the intervention of the superimposing means 8, reaction moments, which may have an interfering effect on the steering wheel 2, are minimized in a simple and advantageous manner. An increase in the amount flowing through, proportional to the rotational speed of the pinion angle δ_{G}, admittedly is aimed for but not possible or meaningful in all areas, since a reaction must be significantly quicker at a low vehicle speed v_{X} and a very high rotational speed of the pinion angle δ_{G} and, correspondingly, a higher gradient must be used. In addition, the maximum adjusting dynamics of the hydraulic pump 12 must be taken into consideration and, under some circumstances, a certain lead should be provided. These dependencies are shown in the characteristics 16 (FIG. 2).

As is evident from FIG. 2, a hydraulic useful function 14 of the method for operating a steering system 1 controls the flow through the hydraulic pump 12 as a function of the vehicle speed v_{X} and of the rotational speed of the pinion angle δ_{G}. By these means, suitable adjusting dynamics and a moment-compatible angle superimposition is achieved. In a preferred embodiment of the invention, this is accomplished by two partial functions 15a, 15b. As input signals, the first partial function 15a receives the requested function status Fₛₜₐₜ from an imposed driving dynamics control or from a defect strategy of the steering system 1 (not shown), the vehicle speed v_{X} in km/h and the pinion angle speed \dot{δ}_{G} in °/sec. The partial function 15a pre-processes the signals v_{X} and δ_{G} at the function inputs. The signals are filtered here and suitable measures are taken if they are not present. Correspondingly, the function status can assume the values of “reset”, “off”, “normal”, “constant control current”, “v_{X} incorrect”, “\dot{δ}_{G} incorrect” and “v_{X} & \dot{δ}_{G} incorrect”.

If the vehicle speed signal v_{X} is incorrect, the function 14 is switched into a safe step-back plane with a constant value for v_{X}. The procedure is similar in the case of an incorrect pinion angle speed δ_{G}.

By means of the characteristics 16, an associated nominal current value i_{dK} is now determined with the prepared or constantly limited signals v_{X} and δ_{G} for the hydraulic pump 12, the range of values being 0 to 1000 mA. This serves as input signal for the partial function 15b, which may, in addition, also obtain a manually specifiable constant value i_{dman}, which can be selected by specifying “constant control current” of the function status Fₛₜₐₜ and finally, on the basis of the specified function status F_{Stat}, determines and puts out the triggering signal i_{d} for the hydraulic pump 12.

The method for operating the inventive steering system 1 advantageously is realized as a computer program on the control device 13. For this purpose, the computer program is stored in a memory element of the control device 13 (not shown). Due to the processing on a microprocessor of the control device 13, the method is carried out constantly at each scanning step. The computer program may be stored on a computer-readable data storage medium (diskette, CD, DVD, hard drive, USB memory stick or the like) or stored on an Internet service as computer program product and transferred from there into a memory element of the control device 13.

1. Power-assisted steering system of a motor vehicle comprising:
a steering handing device for specifying a steering wheel angle (δ_{S}) as a measure of a desired steering angle (δ_{Fm}) for at least one steerable wheel of the motor vehicle,
a steering gear with a pinion, which converts a pinion angle (δ_{G}) which depends on the steering wheel angle (δ_{S}), into the steering angle (δ_{Fm}) of the at least one steerable wheel of the motor vehicle;
superimposing means for producing an additional angle (δ_{M}) and for producing the pinion angle (δ_{G}) from superimposing the additional angle (δ_{M}) on the steering wheel angle (δ_{S}), and
a servo drive with an electronically controllable hydraulic pump for realizing a variable moment support,
the amount flowing through the electronically controllable hydraulic pump being determined as a function of a rotational speed of the pinion angle (\dot{δ}_{G}) and controlled by a control signal (i_{d}) of a control device of the steering system.

2. The steering system of claim 1, wherein the amount flowing through the electronically controllable hydraulic pump additionally is determined as a function of the vehicle speed (v_{X}) and controlled by a control signal (i_{d}) of the control device of the steering system.

3. The steering system of claims 1 or 2, wherein the superimposing means for producing the additional angle (δ_{M}) have a control drive, especially an electric motor, and a superimposing transmission for producing the pinion angle (δ_{G}) from a superimposition on the steering wheel angle (δ_{S}) and the additional angle (δ_{M}).

4. The steering system of claims 1 or 2, wherein the control drive is triggered for producing the additional angle (δ_{M}) by a control signal (δ_{Md}) of the control device of the steering system.

5. The steering system of claims 1 or 2, wherein the amount flowing through the electronically controllable hydraulic pump is increased, especially proportionally, when the rotational speed of the pinion angle (\dot{δ}_{G}) is also increased.

6. The steering system of claims 1 or 2, wherein the control device obtains the rotational speed of the pinion angle (\dot{δ}_{G}) and the vehicle speed (v_{X}) as input quantities, especially from sensors of further vehicle systems or calculates these by means of further input quantities using a suitable model, especially of the steering system.

7. Method for operating a steering system, which runs on the control device of the steering system of claim 1 wherein the amount flowing through the electronically controllable hydraulic pump, is determined by a hydraulic useful function of the control device.

8. The method of claim 7, wherein the hydraulic useful function has at least two partial functions as follows:
a first partial function initiating suitable measures when the input quantities (v_{X}, \dot{δ}_{G}) of the control device are incorrect, and
a second partial function determining the control signal (i_{d}) for controlling the amount flowing through the electronically controllable hydraulic pump.

9. Computer program with program coding means for carrying out a method of operating a power-assisted steering system of one of the claims 7 or 8, wherein the program is carried out on a microprocessor of a computer, especially on the control device of the steering system.

10. Computer program product with program coding means, which are stored on a computer-readable data storage device, in order to carry out a method of operating a power-assisted steering system of one of the claims 7 or 8, wherein the program is carried out on a microprocessor of a computer, especially on the control device of the steering system.

11. Control device for a steering system equipped to carry out a computer program of claim 9.
